(19) United States
(12) Patent Application Publication
(10) Pub. No.: US 2024/0411521 A1
(43) Pub. Date: Dec. 12, 2024

(54) IDENTIFIER GENERATION

(71) Applicant: Pragmatic Semiconductor Limited, Cambridge (GB)

(72) Inventors: Nathanael YOUNG, Sedgefield Durham (GB); Scott WHITE, Sedgefield Durham (GB)

(73) Assignee: Pragmatic Semiconductor Limited, Cambridge (GB)

(21) Appl. No.: 18/703,402

(22) PCT Filed: Oct. 17, 2022
(86) PCT No.: PCT/GB2022/052645

§ 371 Date: Apr. 22, 2024

(30) Foreign Application Priority Data
Oct. 22, 2021 (GB) 2115259.0

(51) Int. Cl. G06F 7/58

(52) U.S. Cl. CPC G06F 7/582

(57) ABSTRACT

A method is disclosed for configuring each item, of a batch of items, with a respective unique identifier. A key set is obtained in which each key of the key set is a random, or pseudo-random, number having a key width that is equal to a predefined code width. For each seed of a set of locally unique seeds, a uniquely invertible function is applied to generate a corresponding code. The uniquely invertible function is configured to convert a seed into a corresponding code using the key set. Every code generated for a given seed of the set of seeds is therefore unique for that set of seeds. The unique identifier is formed from the corresponding code and assigned to an electronic device.

The present invention relates to the generation of identifiers for products. The present invention has particular, but not exclusive, relevance to the generation of globally unique, (pseudo-) random identifiers for integrated circuits or other electronic devices.

Many products, and in particular integrated circuits (ICs) and other electronic devices, require the use of a unique item-level identifier, such that each product has a globally unique identification code, which may be a solely numeric or an alphanumeric code. Where such globally unique identification codes are used it is also generally desirable that the unique code of one product is difficult, or impossible, to predict from the codes of other similar products, for example products manufactured at the same time as, or immediately before or after, that product. This means that it is desirable for the codes applied to each product manufactured to be applied in a random—or pseudo-random—order.

Accordingly, for mass produced products such as ICs, there is a need to be able to generate many millions of unique random identification codes within a given code space. This requires the selection of a respective code for each product from a massive code space. For example, for 64-bit codes the total number of possible code values within the corresponding code space is 2⁶⁴ (or 18446744073709551616).

The need to ensure that each selected code is both unique and (pseudo-) random in the context of such large code spaces is a challenge. For example, one of the simplest techniques for selecting such codes might be to randomly generate a number from within the code space and to check the generated number for uniqueness against a database of previously generated numbers to ensure that the generated number has not previously been generated. If the uniqueness check indicates that a generated number is not a duplicate, then the generated number can be stored in the database for reference during future uniqueness checks. If the uniqueness check indicates that a newly generated number is a duplicate of a previously generated number, then that newly generated number is discarded. The unique numbers may be generated ‘on-demand’, as they are needed, or may be generated and stored in batches, with the stored codes being assigned to products in sequence, from the database, when required. Where an alphanumeric code is required then a unique alpha-numeric code may be generated from one of the generated unique (pseudo-) random numbers.

Whilst this approach works sufficiently well when there are a relatively small number of codes to check against, as the number of assigned/stored codes rises, the process takes longer and longer to perform the uniqueness check. Moreover, as the number of generated codes increases the likelihood of each newly generated code being a duplicate of a previously generated code increases, meaning that the newly generated code has to be discarded. The resulting repetition of the generation and uniqueness check necessitated by such duplications further increases the time to generate the unique (pseudo-) random code.

Whilst employing faster computer processing hardware can help, doing so only postpones the inevitable slow down which, in the extreme, can result in new unique codes taking days to generate because of the need to check every newly generated code against the vast number of codes already generated and stored in the database.

Whilst some mathematical techniques exist that generate unique random numeric or alphanumeric codes, they often do not guarantee that the generated code will always be unique. For example, there may be a finite, albeit small, probability that a duplicate will appear in a number of years or months. Moreover, some techniques do not generate a code in a format that is suitable for use in some coding schemes that specific products require. For example, some techniques generate more than the 36 alphanumeric characters allowed for the web-safe universal resource locators (URL) code structure that some products require.

The invention aims to provide a method and apparatus that overcomes or at least partially ameliorates the above issues.

In one aspect there is provided a method for configuring each item, of a batch of items to be uniquely identified, with a respective unique identifier wherein at least part of each unique identifier comprises a respective code that is unique within the batch of items, the method comprising: determining a code width for the respective code for forming at least part of each unique identifier for a corresponding item of the batch of items; retrieving a key set for the batch of items, the key set comprising at least one key, wherein each key of the key set is a random, or pseudo-random, number having a key width that is equal to the code width; for each seed of a set of seeds, respectively applying a uniquely invertible function to that seed to generate a corresponding code, wherein the uniquely invertible function is configured to convert that seed into the corresponding code using the at least one key of the key set, and wherein each seed of the set of seeds is respectively unique within the set of seeds, whereby every code generated for a given seed of the set of seeds is unique for that set of seeds; for each generated code of at least a subset of the generated codes, forming a respective unique identifier from that code; and for each unique identifier of at least a subset of unique identifiers so formed, configuring a respective item of the set of items with that unique identifier.

The applying the uniquely invertible function to a given seed may comprise applying a block cypher function to that given seed based on the at least one key of the key set. Applying the block cypher function to a given seed may comprise applying an add-rotate-exclusive OR, ‘ARX’, block cypher function to that given seed based on the at least one key of the key set. The applying the uniquely invertible function to a given seed may comprise applying at least an exclusive OR, ‘XOR’, function between that given seed, or an input derived from that given seed, and the at least one key of the key set. The applying the uniquely invertible function to a given seed may comprise applying at least a bitwise rotation, to that given seed or to an input derived from that given seed, by a number of bits that is based on the at least one key of the key set. The applying the uniquely invertible function to a given seed may comprise applying at least a modular addition of that given seed, or of an input derived from that given seed, and the at least one key of the key set. The applying the uniquely invertible function to a given seed may comprise: (a) setting a first key of the key set as a current key and setting that given seed as a current input; (b) applying the uniquely invertible function to the current input to convert the current input into a current output using the current key; (c) in a case where at least one unused key remains in the key list, setting the current output as the current input, setting a next unused key of the key set as the current key and repeating (b) and (c), and in a case where no key remains in the key list, taking the current output as the corresponding code for that given seed.

The forming the respective unique identifier from a given code may comprise adding a common prefix to that given code, optionally wherein the prefix is common to that batch of items and/or to an intended recipient of the items. The forming the respective unique identifier from a given code may comprise adding a suffix to that given code, optionally wherein the suffix comprises at least one cyclic redundancy check (CRC) bit.

The method may further comprise checking a compatibility of each generated code and/or each unique identifier with the generation of American Standard Code for Information Interchange, ‘ASCII’, characters, wherein the configuring of a respective item of the set of items with a unique identifier is performed for a subset of unique identifiers for which the corresponding generated code and/or the unique identifier have been found to be ASCII compatible.

The method may further comprise converting each generated code into a respective string of American Standard Code for Information Interchange, ‘ASCII’, characters. Each string may comprise a predefined number of ASCII characters.

Converting each generated code into the respective string may comprise converting each code into a respective hexadecimal number having a number of hexadecimal digits equal to the predefined number of ASCII characters, and treating each hexadecimal digit of the respective hexadecimal number, arising from conversion of a corresponding code, as an ASCII character, whereby to form the respective string for corresponding code. The determining the code width may comprise determining a binary code width that, when each code is converted into the respective hexadecimal number, will result in the respective hexadecimal number having the number of hexadecimal digits equal to the predefined number of characters for the string.

Converting each generated code into the respective string may comprise dividing each code into a respective set of portions, each set comprising a number of portions that is equal to the predefined number of ASCII characters, and mapping a value of each portion of a respective set of portions, arising from division of a corresponding code, to a corresponding ASCII character in a predefined subset of ASCII characters, whereby to form the respective string for corresponding code. The predefined subset of ASCII characters may be smaller than (e.g. no more than half, quarter, or an eighth the size of), and may comprise ASCII characters selected from, a set of all possible ASCII characters. The mapping the value of each portion of a respective set of portions to a corresponding ASCII character in the predefined subset of ASCII characters may be based on a look-up table. The look-up table may be a look-up table in which at least: a set of possible portion values are arranged in a non-numerical order; or the predefined subset of ASCII characters are arranged in a non-standard (e.g. non-alphabetical or non-ASCII standard) order. The determining the code width may comprise determining a binary code width that, when each code is divided into the respective set of portions, will result in each portion of a respective set of portions having a portion width, comprising a number of bits, that allows each portion to be configured to have any value within a maximum number of values, the maximum number of values being less than or equal to a size, in number of ASCII characters, of the predefined subset of ASCII characters.

In one aspect there is provided apparatus for configuring each item, of a batch of items to be uniquely identified, with a respective unique identifier wherein at least part of each unique identifier comprises a respective code that is unique within the batch of items, the apparatus comprising: means for determining a code width for the respective code for forming at least part of each unique identifier for a corresponding item of the batch of items; means for retrieving a key set for the batch of items, the key set comprising at least one key, wherein each key of the key set is a random, or pseudo-random, number having a key width that is equal to the code width; means for, for each seed of a set of seeds, respectively applying a uniquely invertible function to that seed to generate a corresponding code, wherein the uniquely invertible function is configured to convert that seed into the corresponding code using the at least one key of the key set, and wherein each seed of the set of seeds is respectively unique within the set of seeds, whereby every code generated for a given seed of the set of seeds is unique for that set of seeds; means for, for each generated code of at least a subset of the generated codes, forming a respective unique identifier from that code; and means for, for each unique identifier of at least a subset of unique identifiers so formed, configuring a respective item of the set of items with that unique identifier.

Aspects of the invention extend to computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Embodiments of the invention will now be described, by way of example, with reference to the accompanying drawings in which:

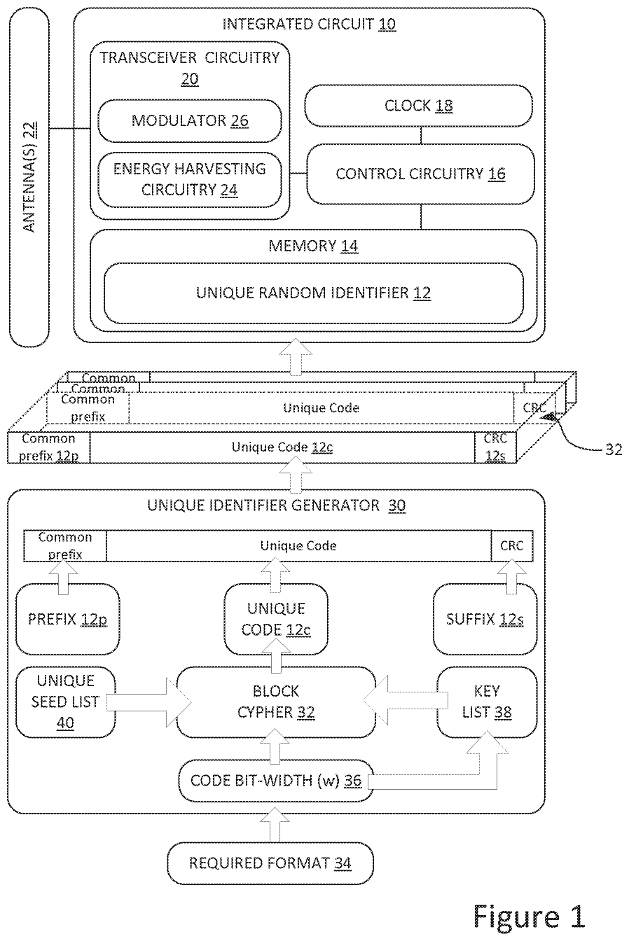

FIG. 1 is a simplified block schematic of an integrated circuit;

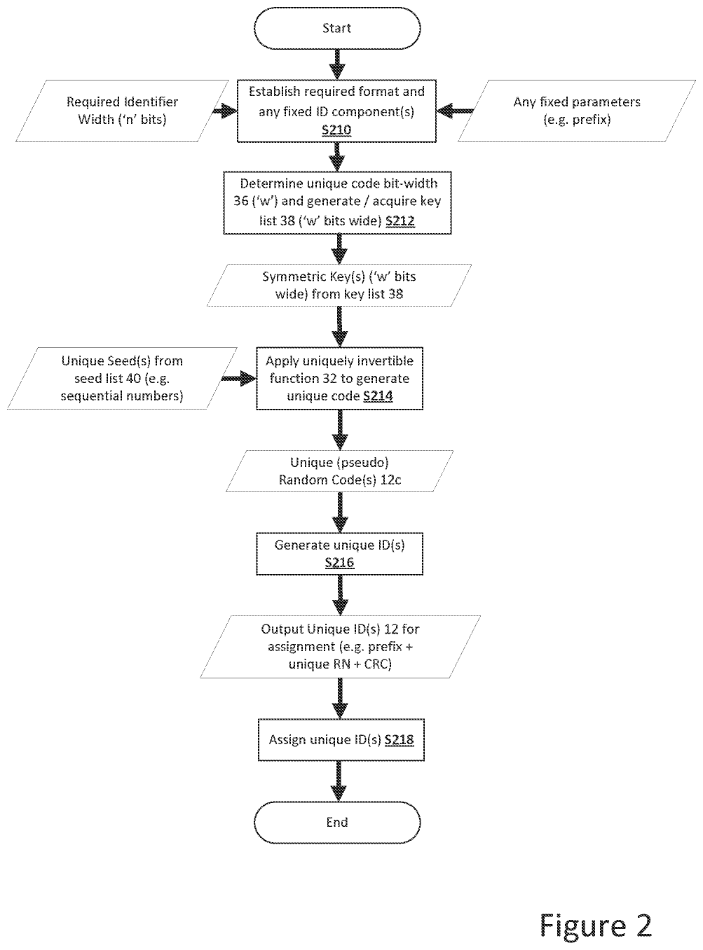

FIG. 2 is a simplified flow diagram illustrating a method for generating unique (pseudo-) random identifiers;

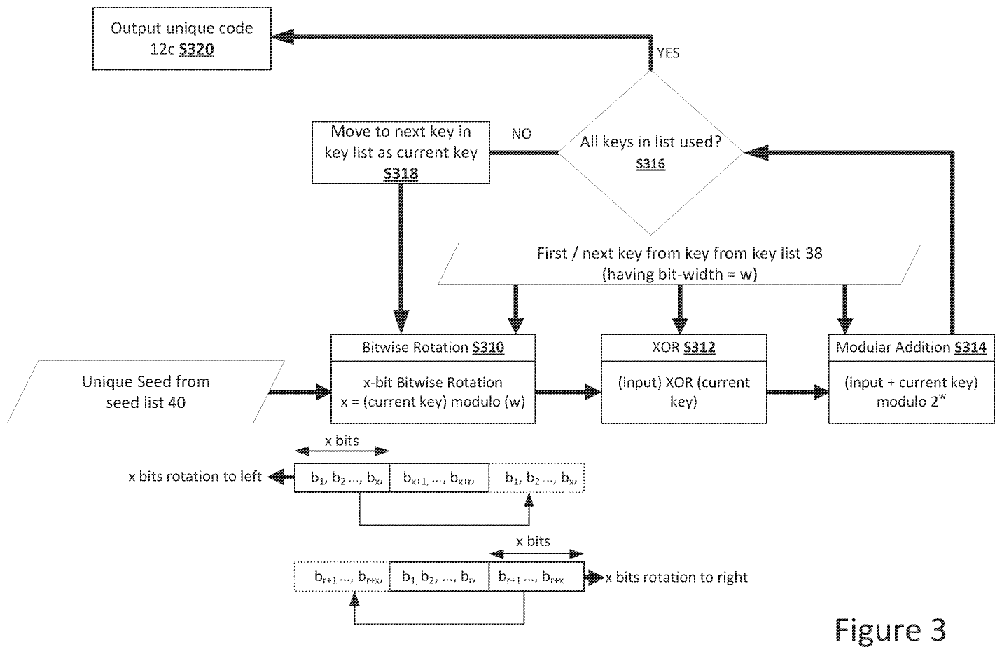

FIG. 3, is a simplified flow diagram illustrating operation of a uniquely invertible function;

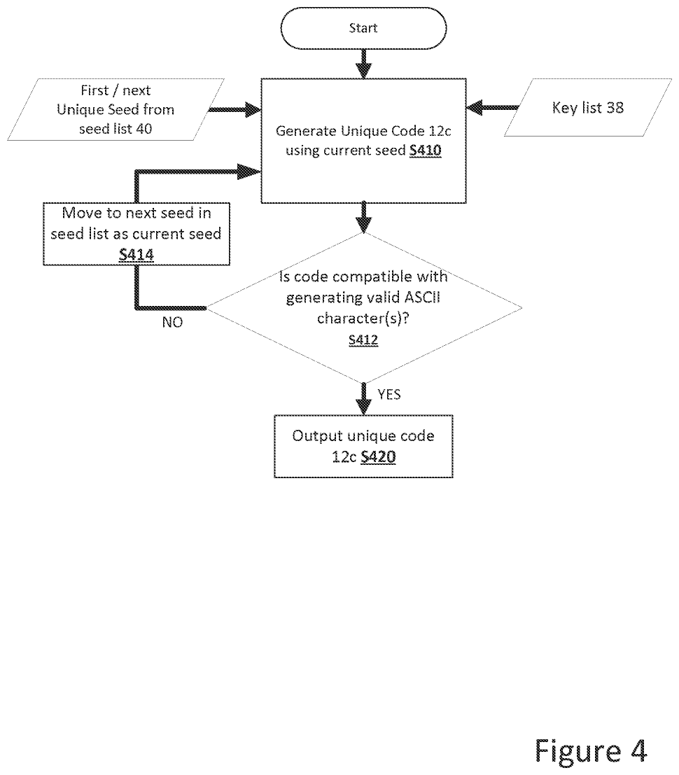

FIG. 4 is a simplified flow diagram illustrating a method for generating ASCII-compatible codes;

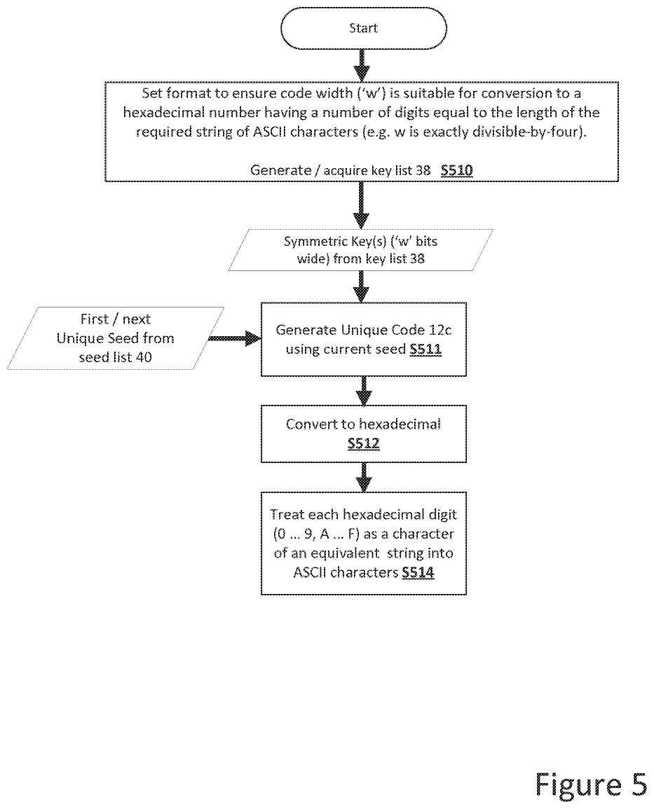

FIG. 5 is a simplified flow diagram illustrating a method for generating valid ASCII characters;

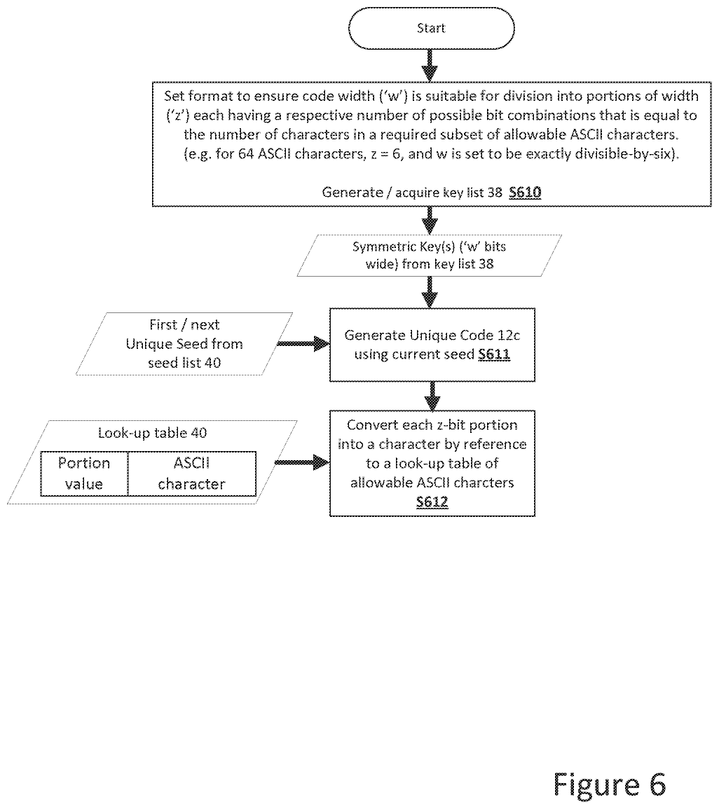

FIG. 6 is a another simplified flow diagram illustrating a method for generating valid ASCII characters; and

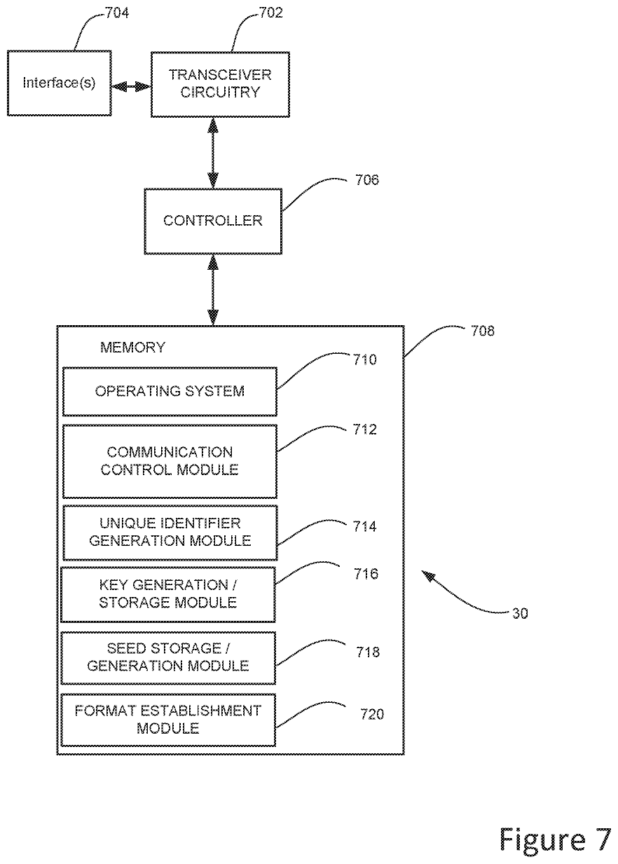

FIG. 7 is a block diagram illustrating the main components of apparatus for implementing a unique identifier generator.

### OVERVIEW

FIG. 1 is a simplified block schematic of an integrated circuit 10 to which a unique random code 12 has been assigned.

The integrated circuit 10 in this example is a Radio Frequency Identification (RFID) integrated circuit for a passive, tags talk only (TTO), RFID tag or the like.

The integrated circuit 10 comprises a memory 14 in which the unique (pseudo-) random identifier 12 is stored.

The integrated circuit 10 also comprises control circuitry 16 for controlling overall operation of the integrated circuit 10, and a clock 18 for providing timing signals for coordinating operation of the control circuitry 16 and hence the various functions of the tag. In this example the memory 14 comprises a programmable read only memory (ROM) such as a PROM that can be laser programmed (i.e., a laser PROM, ‘LPROM’) or the like.

The integrated circuit 10 also comprises transceiver circuitry 20 for receiving radio frequency (RF) excitation signals from an associated RFID reader, via one or more external antennas 22, and for transmitting information from the RFID tag to the RFID reader via the antenna(s) 22 under the control of the control circuitry 16. The transceiver circuitry 20, in this example, comprises energy harvesting circuitry 24 for harvesting energy from received excitation signals to power the integrated circuit 10, and a modulator 26 for modulating signals carrying the information to be transmitted to the RFID reader.

A unique identifier generator 30 is used to generate unique random identifiers 12 in batches for assignment to, and storage in the memory 14 of, the corresponding integrated circuit 10. Specifically, the unique identifier generator 30 generates a batch 32 of unique identifiers 12, each unique identifier 12 respectively comprising, in the illustrated example, a unique (pseudo-) random code 12c, a prefix 12p and a suffix 12s.

The prefix used for each identifier 12, of a batch 32 of identifiers 12 is typically a predetermined prefix that is common to a group of identifiers (for example all the identifiers in a given batch 32 or set of batches 32). In practice, the prefix 12p may be used as an identifier of a particular common attribute or feature associated with the corresponding group of identifiers that shares that prefix 12p. The prefix 12p may, for example, be used as an identifier of a customer for the integrated circuit 10 to which identifiers 12 having the common prefix 12p are assigned.

The suffix 12s in the illustrated example comprises one or more bits to be used as a cyclic redundancy check (CRC) for error detection.

Beneficially, the method utilised to generate the unique random identifiers 12, by the unique identifier generator 30, makes advantageous use of a uniquely invertible function/algorithm (block cypher 32) to generate a unique code 12c that renders each identifier 12 unique, at least for a given prefix 12p where used (or globally unique in the absence of a prefix 12p).

Before the batch 32 of unique identifiers 12 are generated, a required format 34 is established for the unique identifiers 12. The required format 34 may specify, for example, the bit array size for the unique identifiers 12 and/or components thereof, the requirements for the prefix 12p and/or suffix (CRC) 12c, the code validity criteria for the unique identifiers 12 and/or the unique codes 12c (e.g., American Standard Code for Information Interchange (ASCII)-compatible or the like) etc.

Once a format 34 for the batch of unique identifiers is established, as described in more detail later, the unique identifier generator 30 uses the block cypher 32 to generate (pseudo-) random unique codes 12c (taking account of any format requirements) based on:
i) the number of bits in the desired code (or bit-width, ‘w’) 36;
ii) at least one key from a key list 38 of one or more keys; and
iii) a seed, from a seed list 40, that is at least locally unique (e.g., unique for a given prefix 12p, if used).

The unique code 12c is then combined with the prefix 12p and suffix 12s to generate a full, unique, random identifier 12 (which may also be referred to as a ‘full array code’) conforming to the required format.

It will be appreciated that the unique identifier generator 30 may be implemented in any suitable form, for example in software as a computer program (e.g., a web app) or in hardware using dedicated hardware circuitry.

### Unique Identifier Generation

A general method for generating the unique identifiers 12 that may be employed by the unique identifier generator 30 shown in FIG. 1 will now be described in more detail with reference to FIG. 2. FIG. 2 is a simplified flow diagram illustrating a method for generating unique (pseudo-) random identifiers.

As seen in FIG. 2 initially, at S210, a required format for the unique code is established. This format may establish, for example, the required width for the identifier 12, and any fixed parameters such as any required prefix 12p. The established format may also determine the presence and nature of any suffix 12s (such as a CRC) although this may be preconfigured. It will be appreciated that the format may be established based in whole or in part on user input (e.g., via manual selection of the identifier width and/or prefix from a plurality of possible identifier widths and/or prefixes). Nevertheless, the establishment of the format may be partially or fully automated, for example with automated configuration of the identifier width and/or prefix based on predefined or manually selectable parameters.

Once the format is established, the width, ‘w’, for the unique part of the identifier—the unique code 12c—can be determined at S212. It can be seen that the code bit-width 36 may be determined from the required size of the unique identifier 12 and the sizes of any suffix 12s and prefix 12p. Specifically, the code bit-width 36 will be equal to the number of bits remaining, ‘w’, after the total number of bits required for any prefix 12p and suffix 12s are subtracted from the number of bits, ‘n’, required for the final unique identifier 12 (where ‘n’ is typically a power of two such as 16, 32, 64, 128, 256 etc.).

One or more keys having the determined width can thus be obtained (also at S212) for the key list 38. The key(s) of the key list 38 may be generated dynamically ‘on-the-fly’ or may be acquired from memory (e.g., from a pre-populated database). Each key in the key list 38 is a respective random binary number of bit-width equal to the code bit-width 36. The one or more keys in each key list 38 may be generated for, and associated with, a particular format (e.g., a particular prefix 12p identified during format establishment at S210). Once a key list 38 for a particular established format (e.g., associated with a particular prefix 12p) is finalised, the key(s) in the key list 38 remain unchanged and are not added to. This helps to ensure that each code 12c once generated cannot be inadvertently duplicated for that established format/prefix 12p.

The keys in the key list 38, in this example, effectively act as symmetric keys that can be used both as part of an invertible procedure to obtain a unique code 12c from a seed and as part of a reverse procedure that can derive that seed from that unique code 12c.

The key(s) of the key list 38 are provided, together with a seed from the unique seed list 40 as an input to the block cypher function/algorithm 32 to generate, at S214, a corresponding unique 12c. In this example, the list of seeds 40 comprises seeds in the form of unique numbers that have not been used before to generate codes for the same established format (e.g., for the same prefix 12p). The number of seeds required for a given batch of unique codes 12c (and hence for a given batch of unique identifiers 12) will be equal to the number of unique codes 12c in that batch.

Each operation forming part of the block cypher function/algorithm 32 is uniquely invertible for a given key value, and hence any output of each operation can only be generated by a single input. This, together with the use of a new seed from the seed list 40 for each unique code 12c, helps to ensure that all codes 12c generated using the same key(s) are unique. The use of the block cypher function/algorithm 32 together with one or more (pseudo-) randomly generated keys helps to ensure that the resulting unique codes 12c have an acceptable level of randomness (or ‘entropy’) and are therefore difficult to predict.

Each unique code 12c generated at S214 is combined with any corresponding prefix 12p and suffix (e.g., CRC bits) 12s to generate, at S216, a respective unique identifier 12 (or ‘full array code’).

The generation of a new unique code 12c at S214 and the corresponding generation of the associated unique identifier 12 at S216 may be repeated until a sufficiently large list (batch) of unique identifiers (or ‘array codes’) have been generated. It will be appreciated that: a plurality of unique codes 12c (e.g., part or all of an entire batch) may be generated before the corresponding unique identifiers 12 are generated; or each unique identifier 12 may be generated as soon as the respective corresponding unique code 12c has been generated.

Once generated the batch of unique identifiers 12 may be incorporated into a suitable file, from where they may be used to program the integrated circuits 10 (or other products) at S218.

### Block Cypher Function

A possible way in which the uniquely invertible function/algorithm 32 may be implemented will now be described in more detail with reference to FIG. 3, which is a simplified flow diagram illustrating operation of the uniquely invertible function. The uniquely invertible function/algorithm 32 shown in FIG. 3 is known as an add-rotate-XOR (or ‘ARX’) block cypher.

In more detail, the method of generating a unique code of a defined length (or width), ‘w’, shown in FIG. 3 comprises bitwise rotation S310, exclusive OR (XOR) S312, and modular addition S314 steps.

Initially, a seed is taken from the seed list 40 that has not previously been used for the current format (e.g., for a specific prefix 12p). Similarly, a first key is taken, from the key list 38 and is treated as a current key. Bitwise rotation is then performed on the seed, at S310, by a number of bits ‘x’ that is given by (current key) modulo (bit-width w). The modular operation used to define x means that x is the remainder that results upon dividing the current key by the bit width w. The value of x is, therefore, always an integer that is smaller than w.

As seen in FIG. 3, this bitwise rotation by x bits involves shifting the inputted bits by removing x bits from one end of the input and reinserting the removed bits at the other. The bitwise rotation may be in either direction provided the rotation applied is consistent (for a given step in the procedure). For example, the bitwise rotation may comprise rotation by x bits to the left in which the inputted bits are shifted x places to the left by removing x bits from the left-hand end (i.e., the x most significant bits) and reinserting each shifted out bit onto the right-hand end of the number. The bitwise rotation may comprise rotation by x bits to the right in which the inputted bits are shifted x places to the right by removing x bits from the right-hand end (i.e., the x least significant bits) and reinserting each shifted out bit onto the left-hand end of the number.

Following the bitwise rotation at S310, the bitwise shifted seed is applied as an input to a bitwise exclusive OR (XOR) logical operation at S312. This XOR function applies the XOR operation between the input and the current key (i.e. (bitwise rotated seed) XOR (current key)) and therefore outputs a binary number in which; a ‘1’ is found at a bit position in which the corresponding bit of the input and corresponding bit of the current key have different values; and a ‘0’ is found at a bit position in which the corresponding bit of the input and corresponding bit of the current key have the same value.

Following the XOR operation at S312, the XORed and bitwise shifted seed is used as the input to a modular addition function at S314. This modular addition function performs modular addition of the input and the current key with a modulus equal to two raised to the power of the bit-width w (i.e. ((XORed and bitwise shifted seed)+current key) modulo 2^{w}). This modular addition helps to ensure that the output does not exceed the capacity of the bit-width.

If unused keys are present in the key list 38, at S316, then the output of the modular addition function at S314 is applied as an input to the bitwise rotation function at S310. The bitwise rotation function at S310 is then repeated using the output of the modular addition function at S314 as the input and the next key in the key list 38 as the new current key (as indicated by S318). The XOR function at S312 is applied to the resulting output from the reapplied bitwise rotation function at S310 using this new current key. The modular addition function at S314 is applied to the resulting output from the reapplied XOR function at S312 using this new current key. This procedure is repeated until there are no unused keys in the key list 38.

When the keys in the key list 38 have been exhausted the output from the modular addition function at S314 is outputted as the unique code 12c at S320.

It can be seen that the number of repeats depends on the number of keys in the list. The number of keys thus affects the randomness of the unique code with a greater number of keys providing a greater degree of randomness. Nevertheless, as explained above, the codes are guaranteed to be unique regardless of the number of keys, and even with a small number of keys—or even a single key—the randomness can make it challenging to reverse engineer the algorithm even from a relatively large number of products manufactured at the same time (e.g., from a full wafer of programmed integrated circuits). For applications where uniqueness is essential, ultimate randomness is not necessary (nor possible because a truly random code generator would, at some point, generate a duplicate code).

Thus, each seed can be guaranteed unique for a given prefix (manufacturer), for example by allocating seeds sequentially (in numeric order or in some other known—e.g., pseudo random-order), and by preventing access to a seed value in a database once it has already been used (and whilst it is being accessed). For example, the first batch of 1 million codes for a given manufacturer (e.g., prefix 12p) may be generated using seeds taking the values of 1 to 1,000,000.

Beneficially, it can be seen that the method allows a large degree of flexibility in unique identifier/unique code bit-width selection, as the method works well for all bit widths. Moreover, the absence of any need to check the generated codes for uniqueness means that the program takes relatively modest computing power, for typical bit-widths, regardless of batch size.

Specifically, uniqueness and a particularly high level of randomness are provided by the repeated sequence of a rotation to left or right, bitwise XOR, and modular addition albeit that a simplified (or more complex) procedure involving a subset of (or additions to) the described steps may be used depending on requirements.

### ASCII Compatible Codes

For some applications it may be necessary that every unique code (and/or unique identifier) generated is ASCII-compatible and potentially compatible with a reduced set of ASCII characters. For example, integrated circuits which are used to generate uniform resource locator (URLs)—e.g., near field communication (NFC) ‘barcode’ ICs—may require such ASCII-compatibility.

A possible way to achieve this is illustrated in FIG. 4 which is a simplified flow diagram illustrating a method for generating (reduced) ASCII-compatible codes. The method in FIG. 4 may be summarised as a repeat until valid method.

In FIG. 4 the procedure begins by generating a unique code (e.g., as described with reference to FIG. 1, 2 and or 3 above) at S410 using a current seed from the seed list 40 and one or more keys from the key list 38. This code is checked, at S412, for compatibility with the ASCII character requirement. For example, if the generated unique code can be used to generate one or more valid (for the required application) ASCII characters then it is considered to be a valid code but, if not, the generated code is considered to be an invalid code.

If the code is not found to be compatible with valid ASCII characters then the procedure moves to the next seed in the seed list 40 as a current seed and generates a new unique code (e.g., as described with reference to FIG. 1, 2 and or 3 above) at S410 using the new current seed. The check at S412 is then repeated for the new unique code and the procedure continues to repeat until a code 12c is generated that is found to be compatible with generating valid ASCII characters.

Once a valid code 12c is generated it is output as a unique code for assignment to the IC 10 (as described above).

Whilst this technique is effective for ensuring compatibility with ASCII characters with a wide range of codes, it introduces variability into the time taken to generate a valid code.

Another possible way to achieve ASCII compatibility is illustrated in FIG. 5 which is a simplified flow diagram illustrating a method for generating valid ASCII characters. The method in FIG. 5 may be summarised as a “convert to hexadecimal” method.

In FIG. 5 the procedure begins by ensuring at S510 that the required format for the final identifier 32 (e.g. as established at S210 in FIG. 2) is set for the generation of binary codes 12c having bit-width (‘w’) suitable for conversion to a hexadecimal number having a number of hexadecimal digits corresponding to the required number of ASCII-characters in the final string of characters corresponding to the unique code 12c. Since each digit of a hexadecimal number has 16 different possibilities (0 . . . 9, A . . . F) suitable code lengths in this example are divisible by four. By way of example, where the random part of the identifier (i.e. the unique code 12c) is required (when converted to ASCII) to have six characters, the format will be set to ensure a code length of 24 bits. An appropriate key list 38 can then be generated/acquired (e.g. as described for S212 of FIG. 2).

The procedure continues by generating a unique code (e.g., as described with reference to FIG. 1, 2 and or 3 above) at S511 using a current seed from the seed list 40 and one or more keys from the key list 38.

Accordingly, the unique code can be successfully converted to a hexadecimal number (as seen at S512) having a length (in digits) equal to the length in characters of the required ASCII string. Each hexadecimal digit is subsequently treated as (converted to) an ASCII-character of the final ASCII string forming the ASCII version of the unique code 12c at S514. For example, for a six character ASCII string, a 24 bit binary number may be used (e.g. ‘0b010011010010011001010011’ would be converted to the hexadecimal number ‘0x4D2653’, which would be converted, in turn, to the ASCII character string “4D2653”).

Whilst this method avoids significant variability in the time taken to generate a valid code, it limits the range of the available codes that can be used to a restricted number of characters (i.e. 0 . . . 9, A . . . F).

Another possible way to achieve ASCII compatibility is illustrated in FIG. 6 which is another simplified flow diagram illustrating a method for generating valid ASCII characters. The method in FIG. 6 may be summarised as a “look-up table” method.

In FIG. 6 the procedure begins by ensuring at S610 that the required format for the final identifier 32 (e.g. as established at S210 in FIG. 2) is set for the generation of binary codes 12c having bit-width (‘w’) suitable for division into portions of width (‘z’) each having a respective number of possible bit permutations that is equal to the number of characters in a required subset of ASCII-characters. For example, to support a subset of 64 required ASCII characters (which would be sufficient for the ASCII characters suitable for web addresses) the width, ‘z’, of the portions would be six bits because there are 64 possible permutations of six bits (i.e. 2⁶=64). An appropriate key list 38 can then be generated/acquired (e.g. as described for S212 of FIG. 2).

The procedure continues by generating a unique code (e.g., as described with reference to FIG. 1, 2 and or 3 above) at S611 using a current seed from the seed list 40 and one or more keys from the key list 38.

Each z-bit portion is then converted into an ASCII character by virtue to a look-up table that maps every possible value of z (e.g. every permutation of z-bits, or a decimal equivalent of every permutation), to a different respective ASCII character of the subset of allowable ASCII characters, to form a string of allowable ASCII characters. An extract from a simplified exemplary (sequential) look-up/mapping table is shown, for illustrative purposes only, in Table 1 below.

TABLE 1
Extract from example look-up table

| Portion | ASCII |
|---|---|
| Value | character |
| 0b000000 | a |
| 0b000001 | b |
| . . . | |
| 0b000100 | e |
| . . . | |
| 0b001011 | l |
| 0b001100 | m |
| . . . | |
| 0b001111 | p |
| . . . | |
| 0b010010 | s |
| . . . | |

It will be appreciated that the ASCII characters and the respective portion values may be included in a known sequence (e.g. a normal alphabetical/numerical sequence) or may be randomised to make it more difficult to reverse engineer a binary version of the code 12c from an ASCII version.

For example, for a six character ASCII string of characters from a 64 ASCII character subset, a 36 bit binary number may be used (e.g. binary number ‘0b010010000000001100001111001011000100’ could be split into six 6-bit portions ‘0b010010 0b000000 0b001100 0b001111 0b001011 0b000100’, which could be converted, by reference to the illustrative look-up table represented in Table 1, to the ASCII character string “sample”).

Albeit slightly more time consuming than the procedure illustrated in FIG. 5, this method also avoids significant variability in the time taken to generate a valid code without such a limit on the range of the available codes.

### Resilience Against Bad Actors

The code generation method described is designed to provide resilience against an attempt to predict or reproduce the codes for malicious reasons. The risk that such an attack could be successful increases with the number of products available to the attacker. In the case of ICs, thousands of which may be manufactured from a single wafer, acquisition of a batch of coded ICs from the single wafer, together with the seeds used for assigning unique identifiers to those ICs, could theoretically make success more likely in a brute force attempt to derive the keys, the number of iterations of the block cypher, and other aspects of the algorithm used to transform the seeds into the unique identifiers.

Nevertheless, a number of factors mitigate against even this limited vulnerability. Firstly, for example, not all ICs on a wafer will be within specification, but all will be programmed with a unique identifier. Accordingly, there will be seeds without a corresponding working integrated circuit. Secondly, in downstream manufacture of electronic devices incorporating the IC (e.g., RFID tag/inlay manufacture) the ICs may not be picked sequentially from the wafer. Both these factors make it harder to map specific ICs to the corresponding seeds even if the seeds used for generating the identifiers for the batch are known. Any vulnerability could also be further mitigated by randomly allocating unique identifiers across the wafer to ensure that even if the unique IDs are generated from a sequential set of seeds that becomes known to an attacker, there is no correlation between the seed sequence and the order on the wafer.

The reversibility of the code generation sequence may also provide benefits in terms of the ability to detect counterfeit ICs. For example, a reverse algorithm may be applied to a unique identifier that appears, on the face of it, to be valid in order to recover the seed used to generate it. If the seed is out of the known correct range, for example a number higher or lower than any seeds allocated to the relevant manufacturer prefix, then this would be indicative of a counterfeit chip.

FIG. 7 is a block diagram illustrating the main components of exemplary apparatus for implementing the unique identifier generator 30 shown in FIG. 1. As shown, the home unique identifier generator 30 includes transceiver circuitry 702 which is operable to transmit signals to, and to receive signals via one or more wired or wireless interfaces 704. The operation of the transceiver circuitry 702 is controlled by a controller 706 in accordance with software stored in memory 708. The software includes, among other things, an operating system 710, a communication control module 712, a unique identifier generation module 714, a key generation/storage module 716, a seed storage/generation module 718 and a format establishment module 720.

The communication control module 712 is operable to control communication with other entities such as the devices being programmed with the unique identifier, and input and output devices (e.g. display(s), keyboards, sound device, touch screens and/or the like) in the system.

The unique identifier generation module 714 is operable to manage the overall operation of the unique identifier generator 30 as described with reference to FIGS. 1 to 6, such as the application of the block cypher 32 to generate the unique code 12c, the generation and maintenance of prefixes 12p and/or suffixes 12s and formation of the unique identifiers 32 from their component parts (unique code 12c and any prefix 12p or suffix 12s).

The key generation/storage module 716 manages the generation or acquisition and storage of the keys used for the generation of the unique codes 12c. The seed storage/generation module 718 manages the generation or acquisition and storage of the seeds used for the generation of the unique codes 12c. The a format establishment module 720 manages the establishment of the required format for the unique identifiers based, for example, on user input and/or databases of standard prefixes 12p or the like.

### Modifications and Alternatives

A detailed embodiment has been described above. As those skilled in the art will appreciate, a number of modifications and alternatives can be made to the above embodiments whilst still benefiting from the inventions embodied therein.

For example, it will be appreciated that, whilst the beneficial method of assigning unique random codes to products has been described with specific reference to an RFID integrated circuit for a passive TTO RFID tag, the method can be used for any product or other object requiring assignment of a random number. In the RFID field, for example, the method may be used for assigning unique random codes to electronic circuits for any form of RFID tags using any communication protocol, including active tags, tags that operate in accordance with a tags talk first (TTF) protocol and tags that operate in accordance with a reader talks first (RTF) protocol. Moreover, whilst the method is particularly beneficial for RFID type applications, the method also has benefits for electronic circuitry for other non-RFID applications.

For example, whilst the detailed examples provided in the description describe assigning identifiers to items in the form of electronic devices such as integrated circuits, RFID tags or the like, the method described may be beneficially applied for assigning identifiers to any suitable product. For example, the unique identifiers/codes generated using the method could be used to generate bar codes, quick response (QR) codes or any similar codes for applying to physical products. The method could also be used to generate non-sequential unique serial numbers for applying to products for which both traceability and challenging reproducibility are desirable (e.g. bank notes, vehicle chassis, credit cards, weapons, software activation codes).

It will further be appreciated that whilst the unique (pseudo-) random identifier is described as having a predetermined prefix (e.g., acting as a customer identifier) and a suffix comprising a number of CRC bits, the unique identifiers may have only a prefix, only a suffix or neither a prefix nor a suffix. Where present, the prefix and suffix may represent any suitable attribute or feature associated with the unique random code and/or the object to which it is assigned.

It will also be appreciated that the format of the unique identifier may be at least partially fixed (e.g., with a fixed identifier width, and/or fixed prefix/suffix if present).

Moreover, whilst a high degree of uniqueness and randomness—and hence technical benefit—may be provided, in particular, by use of the ARX block cypher function (i.e., the repeated sequence of a rotation to left or right, bitwise XOR, and modular addition as shown in FIG. 3) it is not essential that the uniquely invertible/block cypher function/algorithm uses all of these steps, or that they are used in the order shown in FIG. 3. For example, some benefit may be derived by simply performing a single XOR between the seed and a fixed key, or repeated XORs using a list of keys, albeit that this would not provide the same randomness and level of security.

It is also possible that the order of the steps and/or the steps performed may change for each iteration involving a new key from the key list. Nevertheless, whilst the ordering of the rotation, XOR and modular addition operations in the sequence may have a relatively minor effect on the performance of the method, the resulting code generation is more efficient if the sequence is the same in each repetition of the sequence.

Moreover, any uniquely invertible mathematical function or chained sequence of uniquely invertible functions could potentially be used that provide a required balance between speed of execution, key complexity, and ease of decryption. Other functions that may be used in isolation or in sequence may, for example, include a function that re-orders certain parts of a bit sequence in a known way (e.g. a ‘bit reordering’ or ‘bit mangling’ function). Such a function might, for example, take every other bit (e.g. the even bits or odd bits)—or every n^{th} bit—and insert them at the start of the bit sequence followed by the remaining bits in their original (or reverse) order.

In effect, therefore, the method for generating the unique identifiers can be implemented using one or more specific algorithms for generating the unique code (hence making it virtually impossible to reverse engineer). Specifically, any suitable algorithm that provides a one-to-one (i.e., unique) relationship between a given seed and a unique identifier and that is reversible could be used provided the algorithm provides a sufficient computational difficulty barrier to reverse engineering even if a large set of seeds and unique identifiers are available. Accordingly, even with access to a wafer on which a large number of integrated circuits have been fabricated and programmed with a unique identifier, the use of the method described will make it computationally difficult to decode the key(s) used and near impossible without having a known ordered set of seeds that were used for the unique identifiers.

It will be appreciated that vulnerability to reverse engineering could be further mitigated by random allocation of the generated unique identifier codes across a given batch of products (e.g., across a wafer on which integrated circuits have been fabricated). Hence, even if they have been generated from a known sequential set of seeds, there is no correlation between the seed sequence and the order in the batch (or on the wafer).

Generation of the keys may be achieved in any suitable manner, for example using a standard random number generator. Any suitable number of keys may be provided in a given key list, for generating a batch of unique codes. For example, six keys (i.e., providing for six encryption rounds) for a 36 bit “random” section provides reasonable results. Nevertheless, as the number of encryption rounds (i.e., keys in the key list) increases the apparent randomness (albeit with diminishing returns).

Whilst the methods for generating unique codes provide particular benefits in relation to the assignment of unique identifiers for programming into the memory of ICs (for example for programming an LPROM on a flexible or other integrated circuit) the methods have wider application beyond ICs. For example, the method may be applied beneficially in almost any other situation where a non-sequential, or pseudo-random, identifiers (including numeric or string IDs) are needed. It is particularly beneficial where mathematically guaranteed uniqueness is desirable.

By way of example, other applications include serial number/ID schemes where the production number is sensitive information (e.g., to avoid the so-called ‘German tank’ problem in which information regarding manufacturing rates or the like can be estimated from limited samples of serial numbers assigned sequentially).

Similarly, the methods may find beneficial application for generating inventory IDs for systems where the detection of non-duplicated fake IDs is desirable. Such detection can, for example, be accomplished by inverting the uniquely invertible function to recover the seed and checking if it is above the maximum allocated seed. Depending on the algorithm and database size this process could be many times quicker than a database lookup.

The methods may also find possible utility in pseudorandom number generator (PRNG) based queueing/prioritisation systems. Specifically, each element to be queued or prioritised may be assigned a number (e.g., on a first come first served basis) which would be used as a seed for generating a unique number. Each element could then be queued or prioritised in the order of the resulting generated unique number rather than the original seed order.

It will be appreciated that the check for compatibility with ASCII described with reference to FIG. 4 may be performed at the level of the unique code and/or at the level of the unique identifier.

It can be seen that both the methods of FIG. 5 and FIG. 6 beneficially avoid the need for segmentation of the binary code 12c into the 8-bit segments that would usually be considered necessary for conversion into ASCII. In the method of FIG. 5, for example, each hexadecimal digit corresponds to only four (rather than eight) bits. In the method of FIG. 6, the number of bits, z, in the portions depends on the number of ASCII characters in the subset of allowable ASCII characters. Whilst, in the described example of 64 allowable ASCII characters (a quarter of all possible ASCII characters) the portion size is only 6 bits, a hypothetical 128 allowable ASCII characters (half of all possible ASCII characters) may be represented by seven bits, and a hypothetical 32 allowable ASCII characters (one eight of all possible ASCII characters) may be represented by just five bits.

In the above exemplary apparatus, a number of software modules were described. As those skilled will appreciate, such software modules may be provided in compiled or un-compiled form and may be supplied to the corresponding hardware as a signal over a computer network, or on a recording medium. Further, the functionality performed by part or all of this software may be performed using one or more dedicated hardware circuits. However, the use of software modules is preferred as it facilitates the updating of the corresponding hardware in order to update its functionality. Similarly, although the above embodiments employed transceiver circuitry, at least some of the functionality of the transceiver circuitry can be performed by software.

The functionality of the apparatus may be implemented using one or computer processing apparatus having one or more hardware computer processors programmed using appropriate software instructions to provide the required functionality. It will be further appreciated that all or part of this functionality may be implemented in hardware as dedicated circuitry for example using one or more dedicated integrated circuits such as an application specific integrated circuit (ASIC) or the like.

It will be appreciated that the controller referred to in the description of the apparatus, may comprise any suitable controller such as, for example an analogue or digital controller. Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

Various other modifications will be apparent to those skilled in the art and will not be described in further detail here.

1. A method for configuring each device, of a batch of electronic devices to be uniquely identified with a respective unique identifier, wherein at least part of each unique identifier comprises a respective code that is unique within the batch of electronic devices, the method comprising:
determining a code width for the respective code for forming at least part of each unique identifier for a corresponding electronic device of the batch of electronic devices;
retrieving a key set for the batch of electronic devices, the key set comprising at least one key, wherein each key of the key set is a random, or pseudo-random, number having a key width that is equal to the code width;
for each seed of a set of seeds, respectively applying a uniquely invertible function to that seed to generate a corresponding code, wherein the uniquely invertible function is configured to convert that seed into the corresponding code using the at least one key of the key set, and wherein each seed of the set of seeds is respectively unique within the set of seeds, whereby every code generated for a given seed of the set of seeds is unique for that set of seeds;
for each generated code of at least a subset of the generated codes, forming a respective unique identifier from that code; and
for each unique identifier of at least a subset of unique identifiers so formed, configuring a respective electronic device of the set of electronic devices with that unique identifier.

2. A method as claimed in claim 1 wherein the applying the uniquely invertible function to a given seed comprises applying a block cypher function to that given seed based on the at least one key of the key set.

3. A method as claimed in claim 2 wherein applying the block cypher function to a given seed comprises applying an add-rotate-exclusive OR, ‘ARX’, block cypher function to that given seed based on the at least one key of the key set.

4. A method as claimed in any preceding claim wherein the applying the uniquely invertible function to a given seed comprises applying at least an exclusive OR, ‘XOR’, function between that given seed, or an input derived from that given seed, and the at least one key of the key set.

5. A method as claimed in any preceding claim wherein the applying the uniquely invertible function to a given seed comprises applying at least a bitwise rotation, to that given seed or to an input derived from that given seed, by a number of bits that is based on the at least one key of the key set.

6. A method as claimed in any preceding claim wherein the applying the uniquely invertible function to a given seed comprises applying at least a modular addition of that given seed, or of an input derived from that given seed, and the at least one key of the key set.

7. A method as claimed in any preceding claim wherein the applying the uniquely invertible function to a given seed comprises: (a) setting a first key of the key set as a current key and setting that given seed as a current input; (b) applying the uniquely invertible function to the current input to convert the current input into a current output using the current key; (c) in a case where at least one unused key remains in the key list, setting the current output as the current input, setting a next unused key of the key set as the current key and repeating (b) and (c), and in a case where no key remains in the key list, taking the current output as the corresponding code for that given seed.

8. A method as claimed in any preceding claim wherein the forming the respective unique identifier from a given code comprises adding a common prefix to that given code, optionally wherein the prefix is common to that batch of electronic devices and/or to an intended recipient of the electronic devices.

9. A method as claimed in any preceding claim wherein the forming the respective unique identifier from a given code comprises adding a suffix to that given code, optionally wherein the suffix comprises at least one cyclic redundancy check (CRC) bit.

10. A method as claimed in any preceding claim further comprising checking a compatibility of each generated code and/or each unique identifier with the generation of American Standard Code for Information Interchange, ‘ASCII’, characters, wherein the configuring of a respective electronic device of the set of electronic devices with a unique identifier is performed for a subset of unique identifiers for which the corresponding generated code and/or the unique identifier have been found to be ASCII compatible.

11. A method as claimed in any preceding claim further comprising converting each generated code into a respective string of American Standard Code for Information Interchange, ‘ASCII’, characters.

12. A method as claimed in claim 11 wherein each string comprises a predefined number of ASCII characters, and wherein converting each generated code into the respective string comprises converting each code into a respective hexadecimal number having a number of hexadecimal digits equal to the predefined number of ASCII characters, and treating each hexadecimal digit of the respective hexadecimal number, arising from conversion of a corresponding code, as an ASCII character, whereby to form the respective string for corresponding code.

13. A method as claimed in claim 12 wherein the determining the code width comprises determining a binary code width that, when each code is converted into the respective hexadecimal number, will result in the respective hexadecimal number having the number of hexadecimal digits equal to the predefined number of characters for the string.

14. A method as claimed in claim 11 wherein each string comprises a predefined number of ASCII characters, and wherein converting each generated code into the respective string comprises dividing each code into a respective set of portions, each set comprising a number of portions that is equal to the predefined number of ASCII characters, and mapping a value of each portion of a respective set of portions, arising from division of a corresponding code, to a corresponding ASCII character in a predefined subset of ASCII characters, whereby to form the respective string for corresponding code.

15. A method as claimed in claim 14 wherein the predefined subset of ASCII characters is smaller than (e.g. no more than half, quarter, or an eighth the size of), and comprises ASCII characters selected from, a set of all possible ASCII characters.

16. A method as claimed in claim 14 or 15 wherein the mapping the value of each portion of a respective set of portions to a corresponding ASCII character in the predefined subset of ASCII characters is based on a look-up table.

17. A method as claimed in claim 16 wherein the look-up table is a look-up table in which at least: a set of possible portion values are arranged in a non-numerical order; or the predefined subset of ASCII characters are arranged in a non-standard (e.g. non-alphabetical or non-ASCII standard) order.

18. A method as claimed in any of claims 14 to 17 wherein the determining the code width comprises determining a binary code width that, when each code is divided into the respective set of portions, will result in each portion of a respective set of portions having a portion width, comprising a number of bits, that allows each portion to be configured to have any value within a maximum number of values, the maximum number of values being less than or equal to a size, in number of ASCII characters, of the predefined subset of ASCII characters.

19. Apparatus for configuring each device, of a batch of electronic devices to be uniquely identified, with a respective unique identifier wherein at least part of each unique identifier comprises a respective code that is unique within the batch of electronic devices, the apparatus comprising:
means for determining a code width for the respective code for forming at least part of each unique identifier for a corresponding electronic device of the batch of electronic devices;
means for retrieving a key set for the batch of electronic devices, the key set comprising at least one key, wherein each key of the key set is a random, or pseudo-random, number having a key width that is equal to the code width;
means for, for each seed of a set of seeds, respectively applying a uniquely invertible function to that seed to generate a corresponding code, wherein the uniquely invertible function is configured to convert that seed into the corresponding code using the at least one key of the key set, and wherein each seed of the set of seeds is respectively unique within the set of seeds, whereby every code generated for a given seed of the set of seeds is unique for that set of seeds;
means for, for each generated code of at least a subset of the generated codes, forming a respective unique identifier from that code; and
means for, for each unique identifier of at least a subset of unique identifiers so formed, configuring a respective electronic device of the set of electronic devices with that unique identifier.

20. A computer program product comprising instructions which, when executed by a computer, cause the computer to carry out the method of any of claims 1 to 18.
